(19) United States
(12) Patent Application Publication
(10) Pub. No.: US 2024/0213440 A1
(43) Pub. Date: Jun. 27, 2024

(54) ELECTRODE BODY FOR NON-AQUEOUS RECHARGEABLE BATTERY, NON-AQUEOUS RECHARGEABLE BATTERY, AND METHOD FOR MANUFACTURING ELECTRODE BODY OF NON-AQUEOUS RECHARGEABLE BATTERY

(71) Applicants: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(72) Inventor: Ryotaro SAKAI, Toyohashi-shi (JP)

(73) Assignees: PRIMEARTH EV ENERGY CO., LTD., Kosai-shi, Shizuoka (JP); TOYOTA JIDOSHA KABUSHIKI KAISHA, Toyota-shi, Aichi-ken (JP); PRIME PLANET ENERGY & SOLUTIONS, INC., Tokyo (JP)

(21) Appl. No.: 18/545,659

(22) Filed: Dec. 19, 2023

(30) Foreign Application Priority Data
Dec. 22, 2022 (JP) 2022-205405

(51) Int. Cl. H01M 4/131; H01M 4/139; H01M 4/62; H01M 4/02; H01M 10/0525

(52) U.S. Cl. CPC H01M 4/131; H01M 4/139; H01M 4/625; H01M 2004/021; H01M 10/0525

(57) ABSTRACT

An electrode body for a non-aqueous rechargeable battery includes a positive electrode substrate and a positive electrode mixture layer. A ratio of a specific surface area of the positive electrode plate to a density of the positive electrode mixture layer is 1.0 to 2.0, inclusive. A ratio of a spring constant of the electrode body to the specific surface area of the positive electrode plate is 30 to 80, inclusive.

### BACKGROUND

### 1. Field

The following description relates to an electrode body for a non-aqueous rechargeable battery, a non-aqueous rechargeable battery, and a method for manufacturing an electrode body of a non-aqueous rechargeable battery that improve the battery characteristics.

### 2. Description of Related Art

An electrode body of a non-aqueous rechargeable battery includes a negative electrode plate, a positive electrode plate, and a separator. The negative electrode plate, the positive electrode plate, and the separator are stacked to form the electrode body. Then, the electrode is arranged in a battery case together with a non-aqueous electrolyte solution. In each electrode plate, an electrode mixture layer is formed on an electrode substrate. The electrode mixture layer contains at least an active material. When the electrode plate is manufactured, the specific surface area of the electrode plate affects the characteristics of the non-aqueous rechargeable battery such as the capacity of the non-aqueous secondary battery.

International Publication No. WO2014/017583 describes an example of a method for manufacturing such a non-aqueous rechargeable battery that improves the battery characteristics by increasing the specific surface area of the positive electrode plate and increasing the area of contact between the electrolyte solution and the active material.

The increase in the specific surface area of the positive electrode plate described in International Publication No. WO2014/017583, however, will not always be able to improve the characteristics of the non-aqueous rechargeable battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One general aspect is an electrode body for a non-aqueous rechargeable battery. The electrode body includes a positive electrode plate. The positive electrode plate includes a positive electrode substrate and a positive electrode mixture layer. A ratio of a specific surface area of the positive electrode plate to a density of the positive electrode mixture layer is 1.0 to 2.0, inclusive. A ratio of a spring constant of the electrode body to the specific surface area of the positive electrode plate is 30 to 80, inclusive.

In the above electrode body, the specific surface area of the positive electrode plate is 2.5 m²/g to 4.0 m²/g, inclusive. The density of the positive electrode mixture layer is 2.0 mg/cm3 to 3.5 mg/cm³, inclusive. The spring constant of the electrode body is 120 kN/mm to 240 kN/mm, inclusive.

In the above electrode, the positive electrode mixture layer contains a positive electrode conductive material. The positive electrode conductive material is carbon nanotubes or carbon nanofibers having a specific surface area of 150 m²/g to 300m²/g, inclusive.

A further general aspect is a non-aqueous rechargeable battery including an electrode body. The electrode body includes a positive electrode substrate and a positive electrode mixture layer. A ratio of a specific surface area of the positive electrode plate to a density of the positive electrode mixture layer is 1.0 to 2.0, inclusive. A ratio of a spring constant of the electrode body to the specific surface area of the positive electrode plate is 30 to 80, inclusive.

Another general aspect is a method for manufacturing an electrode body of a non-aqueous rechargeable battery. The electrode body includes a positive electrode substrate and a positive electrode mixture layer. The method includes setting a ratio of a specific surface area of the positive electrode plate to a density of the positive electrode mixture layer to 1.0 to 2.0, inclusive. The method further includes setting a ratio of a spring constant of the electrode body to the specific surface area of the positive electrode plate to 30 to 80, inclusive.

In the above method, the specific surface area of the positive electrode plate is 2.5 m²/g to 4.0 m²/g, inclusive. The density of the positive electrode mixture layer is 2.0 mg/cm³ to 3.5 mg/cm³, inclusive. The spring constant of the electrode body is 120 kN/mm to 240 kN/mm, inclusive.

In the above method, the positive electrode mixture layer contains a positive electrode conductive material. The positive electrode conductive material is carbon nanotubes or carbon nanofibers having a specific surface area of 150 m²/g to 300m²/g, inclusive.

A further aspect is a method for manufacturing a non-aqueous rechargeable battery including an electrode body. The electrode body includes a positive electrode substrate and a positive electrode mixture layer. The method includes setting a ratio of a specific surface area of the positive electrode plate to a density of the positive electrode mixture layer to 1.0 to 2.0, inclusive. The method further includes setting a ratio of a spring constant of the electrode body to the specific surface area of the positive electrode plate to 30 to 80, inclusive.

### BRIEF DESCRIPTION OF THE DRAWINGS

FIG. 1 is a perspective view showing one embodiment of a lithium-ion rechargeable battery.

FIG. 2 is a schematic diagram showing an electrode body of the lithium-ion rechargeable battery.

FIG. 3 is a flowchart illustrating a process for fabricating an electrode plate of the lithium-ion rechargeable battery.

FIG. 4 is a table listing examples and comparative examples of the lithium-ion rechargeable battery.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Present Embodiment

One embodiment of an electrode plate for a non-aqueous rechargeable battery, a non-aqueous rechargeable battery, and a method for manufacturing a non-aqueous rechargeable battery will now be described.

### Lithium-Ion Rechargeable Battery 10

The structure of a lithium-ion rechargeable battery, which is one example of a non-aqueous rechargeable battery, will now be described.

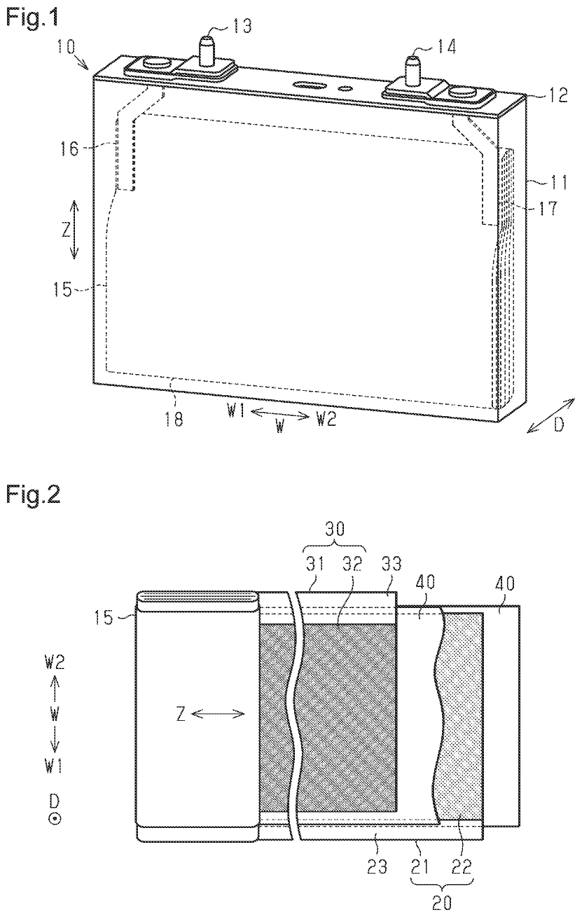

As shown in FIG. 1, a lithium-ion rechargeable battery 10 is formed as a battery cell. The lithium-ion rechargeable battery 10 includes a battery case 11. The battery case 11 includes a lid 12. The battery case 11 includes an open upper end. The lid 12 closes the open upper end. The battery case 11 is formed from a metal such as an aluminum alloy. The lid 12 includes a negative electrode external terminal 13 and a positive electrode external terminal 14 that are used when charging and discharging the lithium-ion rechargeable battery 10. The negative electrode external terminal 13 and the positive electrode external terminal 14 may have any shape.

The lithium-ion rechargeable battery 10 includes an electrode body 15. The electrode body 15 is accommodated in the battery case 11. The lithium-ion rechargeable battery 10 includes a negative electrode collector 16 and a positive electrode collector 17. The negative electrode collector 16 connects the negative electrode of the electrode body 15 to the negative electrode external terminal 13. The positive electrode collector 17 connects the positive electrode of the electrode body 15 to the positive electrode external terminal 14.

The lithium-ion rechargeable battery 10 includes a non-aqueous electrolyte solution 18. The non-aqueous electrolyte solution 18 is injected into the battery case 11 through a liquid inlet (not shown). Attachment of the lid 12 to the open upper end of the battery case 11 forms a sealed battery jar of the lithium-ion rechargeable battery 10. In this manner, the battery case 11 accommodates the electrode body 15 and the non-aqueous electrolyte solution 18.

### Non-Aqueous Electrolyte Solution 18

The non-aqueous electrolyte solution 18 is a composition containing support salt in a non-aqueous solvent. In the present embodiment, ethylene carbonate (EC) is used as the non-aqueous solvent. The non-aqueous solvent may be one or more selected from a group consisting of propylene carbonate (PC), diethyl carbonate (DEC), dimethyl carbonate (DMC), ethyl methyl carbonate (EMC), and the like.

The support salt may be LiPF₆, LiBF₄, LiClO₄, LiAsF₆, LiCF₃SO₃, LiC₄F₉SO₃, LiN(CF₃SO₂)₂, LiC(CF₃SO₂)₃, LiI, or the like. Further, the support salt may be a lithium compound (lithium salt) of one or more selected from these substances. In this manner, the non-aqueous electrolyte solution 18 includes a lithium compound.

### Electrode Body 15

As shown in FIG. 2, the electrode body 15 includes a negative electrode plate 20, a positive electrode plate 30, and separators 40. The longitudinal direction of the electrode body 15 is referred to as the longitudinal direction Z. The thickness direction of the electrode body 15 is referred to as the thickness direction D. The direction intersecting the longitudinal direction Z and the thickness direction D of the electrode body 15 is referred to as the widthwise direction W. The direction toward one side in the widthwise direction W is referred to as the first widthwise direction W1, and the direction toward the other side in the widthwise direction W is referred to as the second widthwise direction W2. The second widthwise direction W2 is opposite the first widthwise direction W1.

The electrode body 15 is formed by stacking the negative electrode plate 20, the positive electrode plate 30, and the separators 40 in the thickness direction D. The separators 40 are arranged between the negative electrode plate 20 and the positive electrode plate 30. More specifically, the separator 40, the positive electrode plate 30, the separator 40, and the negative electrode plate 20 are stacked in this order in the electrode body 15.

The negative electrode plate 20, the positive electrode plate 30, and the separators 40 are stacked in the thickness direction D and then rolled in the longitudinal direction Z to form the electrode body 15. The electrode body 15 is flattened in the thickness direction D at the middle part with respect to the longitudinal direction Z.

The negative electrode plate 20, the positive electrode plate 30, and the separators 40 are stacked in the thickness direction D, which is also referred to as the stacking direction. Further, the negative electrode plate 20, the positive electrode plate 30, and the separators 40 are rolled in the longitudinal direction Z, which is also referred to as the rolling direction. The electrode body 15 is flattened in the thickness direction D.

### Negative Electrode Plate 20

The negative electrode plate 20 functions as one example of a negative electrode of the lithium-ion rechargeable battery 10. The negative electrode plate 20 includes a negative electrode substrate 21 and negative electrode mixture layers 22. The negative electrode substrate 21 is the substrate of the negative electrode. The negative electrode mixture layers 22 are applied to the two opposite sides of the negative electrode substrate 21.

The negative electrode substrate 21 includes a negative electrode connector 23. The negative electrode connector 23 is a region of the negative electrode substrate 21 where there is no negative electrode mixture layer 22 on each of its two sides. The negative electrode connector 23 is arranged at one end of the electrode body 15 in the first widthwise direction W1. The negative electrode connector 23 is exposed from the positive electrode plate 30 and the separators 40 in the first widthwise direction W1.

In the present embodiment, the negative electrode substrate 21 is formed by a Cu foil. The negative electrode substrate 21 serves as a base for the aggregate of the negative electrode mixture layers 22. The negative electrode substrate 21 has the functionality of a collector that collects electric current from the negative electrode mixture layers 22.

The negative electrode mixture layers 22 include a negative electrode active material and a negative electrode additive. The negative electrode plate 20 is formed by, for example, kneading the negative electrode active material and the negative electrode additive and then drying the kneaded negative electrode mixture paste that has been applied to the negative electrode substrate 21.

In the present embodiment, the negative electrode active material can occlude and release lithium ions. A powdered carbon material such as graphite can be used as the negative electrode active material.

The negative electrode additive includes a negative electrode solvent, a negative electrode binder, and a negative electrode thickener. The negative electrode solvent may be, for example, water or the like. The negative electrode binder is, for example, styrene-butadiene rubber (SBR), polyvinylidene fluoride (PVDF), polyvinyl alcohol (PVA), or the like. The negative electrode thickener may be, for example, carboxymethyl cellulose (CMC) or the like. The negative electrode additive may further include, for example, a negative electrode conductive material or the like.

### Positive Electrode Plate 30

The positive electrode plate 30 functions as one example of a positive electrode of the lithium-ion rechargeable battery 10. The positive electrode plate 30 includes a positive electrode substrate 31 and positive electrode mixture layers 32. The positive electrode substrate 31 is the substrate of the positive electrode. The positive electrode mixture layers 32 are applied to the two opposite sides of the positive electrode substrate 31.

The positive electrode substrate 31 includes a positive electrode connector 33. The positive electrode connector 33 is a region of the positive electrode substrate 31 where there is no positive electrode mixture layer 32 on each of its two sides. The positive electrode connector 33 is arranged at one end of the electrode body 15 in the second widthwise direction W2. The positive electrode connector 33 is exposed from the negative electrode plate 20 and the separators 40 in the second widthwise direction W2.

In the present embodiment, the positive electrode substrate 31 is formed by an Al foil or an Al alloy foil. The positive electrode substrate 31 serves as a base for the aggregate of the positive electrode mixture layers 32. The positive electrode substrate 31 has the functionality of a collector that collects electric current from the positive electrode mixture layers 32.

The positive electrode mixture layers 32 include a positive electrode active material and a positive electrode additive. The positive electrode plate 30 is formed by, for example, kneading a positive electrode active material and a positive electrode additive and then drying the kneaded positive electrode mixture paste that has been applied to the positive electrode substrate 31.

The positive electrode active material can occlude and release lithium ions. The positive electrode active material is, for example, a three-element lithium-containing composite metal oxide that contains nickel, cobalt, and manganese (NMC), that is, lithium nickel manganese cobalt oxide (LiNiCoMnO₂). The positive electrode active material may be, for example, at least one of lithium cobalt oxide (LiCoO₂), lithium manganese oxide (LiMn₂O₄), and lithium nickel oxide (LiNiO₂). The positive electrode active material may be, for example, a lithium-containing composite oxide that contains nickel, cobalt, and aluminum (NCA).

The positive electrode additive includes a positive electrode solvent, a positive electrode conductive material, and a positive electrode binder. The positive electrode solvent may be, for example, a non-aqueous solvent such as a solution of N-methyl-2-pyrrolidone (NMP). The positive electrode conductive material may be, for example, carbon fibers such as carbon nanotubes (CNT) or carbon nanofibers (CNF). Alternatively, the positive electrode conductive material may be graphite, carbon black such as acetylene black or ketj en black, or the like. The negative electrode binder may be, for example, the same as the positive electrode binder. The positive electrode additive may further include, for example, a positive electrode thickener or the like.

### Separators 40

The separators 40 are arranged between the negative electrode plate 20 and the positive electrode plate 30. The separators 40 hold the non-aqueous electrolyte solution 18. Each separator 40 is a nonwoven fabric of polypropylene, which is a porous resin, or the like. The separator 40 may be a porous polymer film, such as a porous polyethylene film, a porous polyolefin film, or a porous polyvinyl chloride film. Alternatively, the separator 40 may be a lithium ion or ion conductive polymer electrolyte film. As another option, the separator 40 may be a combination of such films. Immersion of the electrode body 15 in the non-aqueous electrolyte solution 18 results in the non-aqueous electrolyte solution 18 permeating the separators 40 from the ends toward the middle part.

### Manufacturing Process of Lithium-Ion Rechargeable Battery 10

The manufacturing process of the lithium-ion rechargeable battery 10 will now be described.

In the present embodiment, an electrode fabrication process is performed. Battery elements of the lithium-ion rechargeable battery 10 are fabricated in the electrode fabrication step. More specifically, the electrode fabrication process fabricates the negative electrode plate 20 and the positive electrode plate 30 that are the battery elements of the lithium-ion rechargeable battery 10.

An assembling process is performed after the electrode fabrication process. The lithium-ion rechargeable battery 10 is assembled in the assembling process. In the assembling process, the electrode body 15 is first formed. More specifically, the positive electrode plate 30 and the negative electrode plate 20 are stacked with the separators 40 located in between. Then, the stack is rolled and pressed into a flattened roll. Further, the opposing parts of the negative electrode connector 23 in the roll are pressed, and the opposing parts of the positive electrode connector 33 in the roll are pressed. The electrode body 15 is formed in this manner.

Then, the electrode body 15 is arranged in the battery case 11. The positive electrode connector 33 is electrically connected by the positive electrode collector 17 to the positive electrode external terminal 14. The negative electrode connector 23 is electrically connected by the negative electrode collector 16 to the negative electrode external terminal 13. The open end of the battery case 11 is closed by the lid 12. Further, the non-aqueous electrolyte solution 18 is injected into the battery case 11. After injecting the non-aqueous electrolyte solution 18 into the battery case 11, the battery case 11 is sealed. The lithium-ion rechargeable battery 10 is assembled in such a manner.

### Electrode Fabrication Process

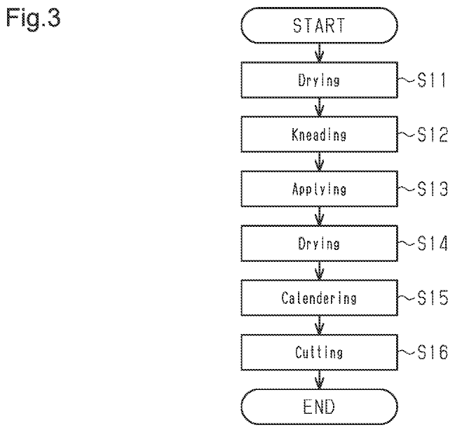

The electrode fabrication process of the present embodiment will now be described with reference to FIG. 3. Hereafter, the process for fabricating the positive electrode plate 30 will be described, and the process for fabricating the negative electrode plate 20 will not be described.

As shown in FIG. 3, step Sll is a mixing step. In the mixing step, the positive electrode active material and the positive electrode additive, which are the raw materials of the positive electrode mixture layers 32, are mixed. This forms the positive electrode mixture paste. Step S12 is a kneading step. In the kneading step, the positive electrode mixture paste is kneaded.

After the kneading step, an applying step is performed in step S13. In the applying step, the positive electrode mixture paste is applied to the two opposite sides of the positive electrode substrate 31. This forms the positive electrode connector 33 along each of the two widthwise ends of the positive electrode substrate 31. Step S14 is a drying step. In the drying step, the positive electrode mixture paste applied to the positive electrode substrate 31 is dried to form the positive electrode mixture layers 32.

After the drying step, a calendering step is performed in step S15. In the calendering step, the positive electrode mixture layers 32 formed on the two sides of the positive electrode substrate 31 are calendered to increase the strength adhering the positive electrode mixture layers 32 to the positive electrode substrate 31 and to adjust the thickness of the positive electrode mixture layers 32.

After the calendering step, a cutting step is performed in step S16. In the cutting step, the positive electrode plate 30 is cut at the middle in the widthwise direction W. This step obtains two positive electrode plates 30.

### Method for Manufacturing Positive Electrode Plate 30

A method for manufacturing the positive electrode plate 30 will now be described in detail.

The specific surface area of the positive electrode plate 30 is adjusted when fabricating the positive electrode plate 30. The specific surface area is measured using, for example, a gas adsorption measurement technique using the Brunauer-Emmett-Teller (BET) theory, that is, the BET method. The specific surface area of the positive electrode plate 30 is the specific surface area of the positive electrode active material after the positive electrode plate 30 is manufactured, not before the positive electrode plate 30 is manufactured. After the positive electrode plate 30 is manufactured is defined as subsequent to the electrode fabrication process. In the description hereafter, the specific surface area of the positive electrode plate 30 after the positive electrode plate 30 is manufactured may be referred to as the positive electrode plate specific surface area.

The positive electrode plate specific surface area is adjusted in the calendering step. The positive electrode plate specific surface area is equivalent to the specific surface area of the positive electrode plate 30 after the calendering step. That is, the positive electrode plate specific surface area is the specific surface area of the positive electrode plate 30 after calendering is performed in the calendering step.

The density of the positive electrode mixture layers 32 is also adjusted when fabricating the positive electrode plate 30. The density of the positive electrode mixture layers 32 is the density after the positive electrode plate 30 is manufactured. In the description hereafter, the density of the positive electrode mixture layers 32 after the positive electrode plate 30 is manufactured may be referred to as the positive electrode density.

Further, the spring constant of the electrode body 15 including the positive electrode plate 30 is adjusted when fabricating the positive electrode plate 30. The spring constant of the electrode body 15 is the constant after the electrode body 15 is manufactured. Thus, the spring constant of the electrode body 15 is the spring constant of the lithium-ion rechargeable battery 10 that forms a battery cell. The spring constant of the electrode body 15 after the electrode body 15 is manufactured is in accordance with the spring constant of the positive electrode plate 30 after the positive electrode plate 30 is manufactured. In the description hereafter, the spring constant of the electrode body 15 may be referred to simply as the spring constant.

More specifically, the positive electrode plate 30 is fabricated so that the ratio of the positive electrode plate specific surface area to the positive electrode density is 1.0 or greater. Further, the positive electrode plate 30 is fabricated so that the ratio of the positive electrode plate specific surface area to the positive electrode density is preferably 2.0 or less.

The positive electrode plate 30 is fabricated so that the ratio of the spring constant to the positive electrode plate specific surface area is 80 or less. Further, the positive electrode plate 30 is fabricated so that the ratio of the spring constant to the positive electrode plate specific surface area is preferably 30 or greater.

In addition, the positive electrode plate specific surface area is, preferably, 2.5 m²/g to 4.0 m²/g, inclusive. In this case, the specific capacity of the positive electrode is 140 mAh/g to 160 mAh/g, inclusive. Preferably, the positive electrode density is 2.0 mg/cm³ to 3.5 mg/cm³. Preferably, the spring constant is 120 kN/mm to 240 kN/mm, inclusive.

### EXAMPLES AND COMPARATIVE EXAMPLES

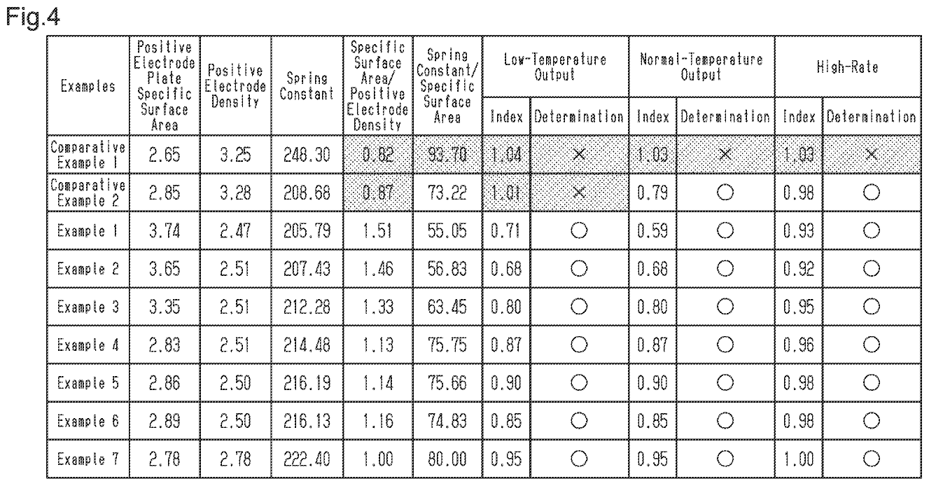

Examples and comparative examples of the lithium-ion rechargeable battery 10 will now be described with reference to FIG. 4. No limitations are imposed by the examples, comparative examples, and conditions illustrated in FIG. 4.

In the examples and comparative examples, a lithium-containing composite oxide containing nickel cobalt aluminum (NCA) or the three-element lithium-containing composite oxide is used as the positive electrode active material. In the examples and comparative examples, the positive electrode conductive material is carbon nanotubes or carbon nanofibers having a specific surface area of 150 m²/g to 300 m²/g. In the examples and comparative examples, the positive electrode plate specific surface area is adjusted by the calender in the calendering step. Calendering is performed in the calendering step at a calendering pressure of 50 kN to 196 kN, inclusive, and a calendering speed of 6 m/min to 120 m/min, inclusive. Further, typical negative electrode plates 20 and separators 40 are used in the electrode bodies 15 of the examples and comparative examples.

Under the conditions described above, the examples and comparative examples of different positive electrode plate specific surface areas, positive electrode densities, and spring constants were observed. The observation results are shown in the table of FIG. 4. The table shows the positive electrode plate specific surface area, the positive electrode density, the spring constant, the ratio of the positive electrode plate specific surface area to the positive electrode density, the ratio of the spring constant to the positive electrode plate specific surface area, and the characteristic observation results for each of the examples and comparative examples.

The characteristics include a low-temperature output characteristic, a normal-temperature output characteristic, and a high-rate characteristic of the lithium-ion rechargeable battery 10. The table shows the index used for the observation of each characteristic and the observation result. The low-temperature output characteristic is the output characteristic of the lithium-ion rechargeable battery 10 under low temperatures. The reaction resistance of the lithium-ion rechargeable battery 10 is used as the index for this characteristic. The normal-temperature output characteristic is the output characteristic of the lithium-ion rechargeable battery 10 under normal temperatures. The diffusion resistance of the lithium-ion rechargeable battery 10 is used as the index for this characteristic. The high-rate characteristic is the characteristic of the lithium-ion rechargeable battery 10 during rapid charging and discharging. The direct current (DC) resistance of the lithium-ion rechargeable battery 10 is used as the index for this characteristic. When the value of an index is 1 or less, this will indicate that the corresponding characteristic is in an appropriate range. The observation results are marked in the table.

In the first comparative example, the ratio of the positive electrode plate specific surface area to the positive electrode density was less than 1.0 and not 1.0 or greater. Further, the ratio of the spring constant to the positive electrode density was greater than 80 and not 80 or less. Under such a situation, in the first comparative example, none of the low-temperature output characteristic, the normal-temperature output characteristic, and the high-rate characteristic were in the appropriate range.

In the second comparative example, the ratio of the spring constant to the positive electrode density was 80 or less but the ratio of the positive electrode plate specific surface area to the positive electrode density was less than 1.0 and not 1.0 or greater. Under such a situation, in the second comparative example, the normal-temperature output characteristic and the high-rate characteristic were in the appropriate range but the low-temperature output characteristic was not in the appropriate range.

In each of the first to seventh examples, the ratio of the positive electrode plate specific surface area to the positive electrode density was in the range of 1.0 to 2.0, inclusive. Further, the ratio of the spring constant to the positive electrode density was in the range of 30 to 80, inclusive. Under such a situation, in the first to seventh examples, the low-temperature output characteristic, the normal-temperature output characteristic, and the high-rate characteristic were all in the appropriate range.

### Observation of Examples and Comparative Examples

As described above, in each of the first and second comparative examples, the low-temperature output characteristic was not in the appropriate range. It is understood that when the positive electrode plate specific surface area is increased, the positive electrode density will become greater than the appropriate range and adversely affect the reaction resistance and the diffusion resistance. In particular, when the positive electrode density becomes greater than the appropriate range, the pores in the positive electrode plate 30 become insufficient. This lowers the transfer speed of lithium ions and adversely affects the reaction resistance and the diffusion resistance.

In the first comparative example, the normal-temperature output characteristic and the high-rate characteristic were also not in the appropriate range. It is understood that when the positive electrode plate specific surface area is increased, the spring constant will become greater than the appropriate range and adversely affect the DC resistance and the high-rate characteristic. In particular, when the spring constant becomes greater than the appropriate range, the electrode expansion and contraction efficiency during charging and discharging decreases. This lowers the transfer efficiency of the non-aqueous electrolyte solution 18 and adversely affects the DC resistance and the high-rate characteristic.

Thus, when the positive electrode plate specific surface area is increased, as long as the positive electrode density is kept within the appropriate range, there will be no adverse effects on the reaction resistance and the diffusion resistance. Further, when the positive electrode plate specific surface area is increased, as long as the spring constant is kept within the appropriate range, there will be no adverse effects on the DC resistance and the high-rate characteristic.

### Advantages of Present Embodiment

The advantages of the embodiment will now be described.

(1) The ratio of the positive electrode plate specific surface area to the positive electrode density is 1.0 to 2.0, inclusive. The ratio of the spring constant to the positive electrode density is 30 to 80, inclusive. Thus, even if the positive electrode plate specific surface area is increased, each of the positive electrode density and the spring constant are in the appropriate range. That is, the positive electrode density will not be excessively high, and the spring constant will not be excessively low. An increase in the positive electrode plate specific surface area will increase the area of contact between the non-aqueous electrolyte solution 18 and the positive electrode active material. In this case, as long as each of the positive electrode density and the spring constant is within the appropriate range, there will be no adverse effects on the internal resistance of the lithium-ion rechargeable battery 10. This improves the characteristics of the lithium-ion rechargeable battery 10.

(2) The positive electrode plate specific surface area is 2.5 m²/g to 4.0 m²/g, inclusive. Further, the positive electrode density is 2.0 mg/cm³ to 3.5 mg/cm³, inclusive. Thus, the positive electrode plate specific surface area can be increased to increase the area of contact between the non-aqueous electrolyte solution 18 and the positive electrode active material without adverse affecting the internal resistance of the lithium-ion rechargeable battery 10. This improves the characteristics of the lithium-ion rechargeable battery 10.

(3) The positive electrode conductive material is carbon nanotubes or carbon nanofibers having a specific surface area of 150 m²/g to 300 m²/g, inclusive. Thus, the positive electrode conductive material, which is highly conductive, will not have adverse effects on the internal resistance of the lithium-ion rechargeable battery 10. This improves the characteristics of the lithium-ion rechargeable battery 10.

### Modified Examples

The above embodiment may be modified as described below. The above embodiment and the following modifications can be combined as long as there is no technical contradiction.

In the above embodiment, for example, the positive electrode active material, the positive electrode conductive material, the positive electrode solvent, and the positive electrode binder may be of any type.

The present disclosure is applied to the lithium-ion rechargeable battery 10 in the above embodiment but may be applied to a different type of a rechargeable battery.

In the above embodiment, the lithium-ion rechargeable battery 10 has the form of a thin plate and is mounted on a vehicle. Instead, the lithium-ion rechargeable battery 10 may be a cylindrical battery. Further, the lithium-ion rechargeable battery 10 may be applied to a marine vessel or an aircraft. Alternatively, the lithium-ion rechargeable battery 10 of the present invention may be used as a stationary battery.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electrode body for a non-aqueous rechargeable battery, the electrode body comprising:
a positive electrode plate including a positive electrode substrate and a positive electrode mixture layer;
a ratio of a specific surface area of the positive electrode plate to a density of the positive electrode mixture layer being 1.0 to 2.0, inclusive; and
a ratio of a spring constant of the electrode body to the specific surface area of the positive electrode plate being 30 to 80, inclusive.

2. The electrode body according to claim 1, wherein:
the specific surface area of the positive electrode plate is 2.5 m²/g to 4.0 m²/g, inclusive;
the density of the positive electrode mixture layer is 2.0 mg/cm³ to 3.5 mg/cm³, inclusive; and
the spring constant of the electrode body is 120 kN/mm to 240 kN/mm, inclusive.

3. The electrode body according to claim 1, wherein:
the positive electrode mixture layer contains a positive electrode conductive material; and
the positive electrode conductive material is carbon nanotubes or carbon nanofibers having a specific surface area of 150 m²/g to 300 m²/g, inclusive.

4. A non-aqueous rechargeable battery, comprising:
the electrode body according to claim 1.

5. A method for manufacturing an electrode body of a non-aqueous rechargeable battery, the electrode body including a positive electrode substrate and a positive electrode mixture layer, the method comprising:
setting a ratio of a specific surface area of the positive electrode plate to a density of the positive electrode mixture layer to 1.0 to 2.0, inclusive; and
setting a ratio of a spring constant of the electrode body to the specific surface area of the positive electrode plate being 30 to 80, inclusive.

6. The method according to claim 5, wherein:
the specific surface area of the positive electrode plate is 2.5 m²/g to 4.0 m²/g, inclusive;
the density of the positive electrode mixture layer is 2.0 mg/cm³ to 3.5 mg/cm³, inclusive; and
the spring constant of the electrode body is 120 kN/mm to 240 kN/mm, inclusive.

7. The method according to claim 5, wherein:
the positive electrode mixture layer contains a positive electrode conductive material; and
the positive electrode conductive material is carbon nanotubes or carbon nanofibers having a specific surface area of 150 m²/g to 300 m²/g, inclusive.

8. A method for manufacturing a non-aqueous rechargeable battery including an electrode body, the electrode body including a positive electrode substrate and a positive electrode mixture layer, the method comprising:
setting a ratio of a specific surface area of the positive electrode plate to a density of the positive electrode mixture layer to 1.0 to 2.0, inclusive; and
setting a ratio of a spring constant of the electrode body to the specific surface area of the positive electrode plate to 30 to 80, inclusive.
